(19) United States
(12) Patent Application Publication
(10) Pub. No.: US 2005/0264431 A1
(43) Pub. Date: Dec. 1, 2005

(54) Forwarding system for long-range preemption and corridor clearance for emergency response

(76) Inventor: Aaron D. Bachelder, Irvine, CA (US)

Correspondence Address: CHRISTIE, PARKER & HALE, LLP, PO BOX 7068, PASADENA, CA, 91109-7068, US

(21) Appl. No.: 10/942,498

(22) Filed: Sep. 15, 2004

Related U.S. Application Data
(63) Continuation-in-part of application No. 10/811,075, filed on Mar. 24, 2004.
Application No. 10/811,075 is a continuation-in-part of application No. 10/642,435, filed on Aug. 15, 2003, now Pat. No. 6,940,422.
(63) Continuation-in-part of application No. 10/704,530, filed on Nov. 7, 2003.
(63) Continuation-in-part of application No. 10/696,490, filed on Oct. 28, 2003.
(63) Continuation-in-part of application No. 10/410,582, filed on Apr. 8, 2003.
(60) Provisional application No. 60/503,144, filed on Sep. 15, 2003.
(60) Provisional application No. 60/403,916, filed on Aug. 15, 2002.
(60) Provisional application No. 60/425,020, filed on Nov. 8, 2002.
(60) Provisional application No. 60/422,144, filed on Oct. 29, 2002.
(60) Provisional application No. 60/371,037, filed on Apr. 9, 2002.

(51) Int. Cl. G08G 1/07

(52) U.S. Cl. 340/906

(57) ABSTRACT

Systems for and methods of preempting intersections by forwarding preemption requests from one intersection to another are described. In one aspect of the invention, congestion can be cleared from the path of a preempting vehicle by facilitating the flow of traffic in front of the vehicle. In another aspect of the invention a preemption corridor is created. Additionally, the preemption corridor can be further cleared by preempting side streets to the preemption corridor. One embodiment of the invention includes a microcontroller configured to receive forwarded preemption requests from a network. In addition, the microcontroller is configured to evaluate information included in a preemption request against a predetermined set of criteria and the microcontroller is configured to preempt a sequence of traffic signals when the information forwarded in a preemption request satisfies the predetermined set of criteria.

### CROSS-REFERENCE TO RELATED APPLICATION

This application claims priority to U.S. Provisional Application No. 60/503,144 filed Sep. 15, 2003, the disclosure of which is incorporated herein by reference.

### BACKGROUND

The present invention relates generally to traffic signal control systems and more specifically to traffic signal preemption systems.

Traffic signals are vital to managing traffic flow. Coordinating traffic signals using traffic signal control systems can greatly ease congestion. However, certain emergencies can necessitate the preemption of traffic signals in order to speed the passage of an emergency vehicle to its destination. A number of systems have been proposed to achieve the preemption of a traffic signal as an emergency vehicle approaches an intersection. These systems utilize a variety of communication techniques to convey information between the vehicle and the intersection including optical signals and radio or wireless communications signals.

### SUMMARY OF THE INVENTION

Embodiments of the present invention enable the preemption of intersections along a corridor for emergency vehicles. In one aspect of the present invention, the preemption corridor can clear traffic from the path of the emergency vehicle, which increases the speed at which the vehicle can travel along the corridor. One embodiment of the present invention includes, a microcontroller configured to receive forwarded preemption requests from a network. In addition, the microcontroller is configured to evaluate information included in a preemption request against a predetermined set of criteria and the microcontroller is configured to preempt a sequence of traffic signals when the information forwarded in a preemption request satisfies the predetermined set of criteria. The network can be a wired or wireless network.

A further embodiment also includes an intersection controller having preemption inputs, a long-range preemption module that is connected to the intersection controller preemption inputs and which includes the microcontroller and a transceiver and a preemption device connected to the long range preemption module.

Another embodiment of the invention includes an intersection controller including the microcontroller and having preemption inputs, a preemption device connected to the intersection controller via the preemption inputs and a transceiver connected to the intersection controller.

In a still further embodiment, the preemption request is forwarded from a traffic signal controller that includes an intersection controller, the traffic signal controller is located at a preempted intersection and the forwarded preemption request includes information concerning the geographic location of the preempted intersection and the state of the preemption inputs of the intersection controller of the preempted intersection.

In yet another embodiment, the forwarded preemption request was generated in response to a preempting vehicle and the microprocessor is configured to evaluate the information by generating an estimated time of arrival for the preempted vehicle using a velocity window. In addition, the microprocessor can be configured to evaluate the information by determining the velocity window based on present traffic conditions.

In a still further embodiment again, the microprocessor is configured to resolve preemption requests made directly to the traffic signal controller by a vehicle and forwarded preemption requests. In addition, the preemption request from the vehicle and the forwarded preemption request can include priority information and the microprocessor can be configured to preempt a traffic signal sequence in a manner consistent with the highest priority preemption request.

Still yet another embodiment of the invention includes a plurality of traffic signal controllers. In addition, at least one traffic signal controller includes a preemption device that can be preempted by a vehicle equipped with hardware capable of communicating a preemption request to the preemption device, the traffic signal controller is configured to send a forwarded preemption requests via a network and at least one of the traffic signal controllers is configured to receive the forwarded preemption request via the network. Furthermore, the network can be wireless or wired.

An embodiment of the method of the present invention includes receiving a preemption request forwarded from another intersection, determining whether the forwarded preemption request satisfies at least one predefined criteria, determining whether the forwarded preemption request conflicts with any preemption request currently being honored by the intersection, and when the preemption request satisfies the predefined criteria and does not conflict with other preemption requests, preempting the intersection and forwarding the preemption request to neighboring intersections. Moreover, the preemption request can include information concerning the geographic location of the intersection that is the source of the preemption request and the manner in which the preempted intersection has been preempted.

In a further embodiment of the method of the invention, the forwarded preemption request was originated at an originating intersection. In addition, determining whether the forwarded preemption request satisfies at least one predefined criteria involves determining whether the originating intersection is within a predetermined distance of the intersection.

In another embodiment of the method of the invention, a vehicle preempted an originating intersection that forwarded the preemption request. In addition, determining whether the forwarded preemption request satisfies at least one predefined criteria involves determining whether the vehicle will arrive at the intersection with sufficient probability.

In a still further embodiment of the method of the invention, a vehicle preempted an originating intersection that forwarded the preemption request. In addition, determining whether the forwarded preemption request satisfies at least one predefined criteria involves determining whether the vehicle will arrive at the intersection within a predetermined time.

In yet another embodiment of the method of the invention, the forwarded preemption request is assigned a priority, other preemption requests are also assigned priorities and determining whether the forwarded preemption request conflicts with any preemption request currently being honored by the intersection comprises determining whether the forwarded preemption request is of a higher priority than all other preemption requests.

In a still further embodiment of the method of the invention again, the other preemption requests can include at least one preemption request made directly to the intersection by a vehicle. In addition, the other preemption requests can include at least one other preemption request forwarded to the intersection by another intersection. In still yet another embodiment of the invention, preempting the intersection comprises establishing both traffic and pedestrian signals in accordance with the preemption request.

In a still further additional embodiment of the method of the invention, forwarding the preemption request to neighboring intersections involves broadcasting the preemption request over a wireless network and/or sending the preemption request to neighboring intersections via a wired network.

### BRIEF DESCRIPTION OF THE DRAWINGS

FIG. 1 is a schematic diagram of a preemption system in accordance with an embodiment of the present invention;

FIG. 2 is a semi-schematic circuit diagram of a traffic signal controller in accordance with the present invention that includes a traditional preemption system and a long-range preemption module;

FIG. 3 is a flow diagram that illustrates a process in accordance with an embodiment of the present invention for achieving long-range preemption of a distant intersection;

FIG. 4 is a flow diagram that illustrates the resolution of conflicts between local preemption requests and long-range preemption requests;

FIG. 5 is a schematic diagram illustrating the impact a traffic control system in accordance with an embodiment of the present invention can have on traffic flow;

FIG. 6 is a semi-schematic circuit diagram of an embodiment of a traffic signal controller in accordance with the present invention that includes an intersection controller and a long-range preemption module;

FIG. 7 is a semi-schematic circuit diagram of an embodiment of a traffic signal controller in accordance with the present invention that includes an intersection controller and a long-range preemption module that is connected to a wired network;

FIG. 8 is a semi-schematic circuit diagram of an embodiment of a traffic signal controller in accordance with the present invention that includes an intersection controller programmed in accordance with the present invention and connected to a preemption device and a transceiver; and

FIG. 9 is a semi-schematic circuit diagram of an embodiment of a traffic signal controller in accordance with the present invention that includes an intersection controller programmed in accordance with the present invention and connected to a preemption device and a wired network.

### DETAILED DESCRIPTION OF THE INVENTION

Embodiments of the present invention include a preemption system capable of preempting the traffic signals of an inbound intersection and long-range preemption modules at distant intersections. The long-range preemption modules are capable of preempting the traffic signals of the distant intersection in response to the preemption of the inbound intersection. In one aspect of the invention, long-range preemption is used to clear corridors along routes that a preempting vehicle is likely to follow. The long-range preemption can speed the vehicle's passage by clearing congestion in its path.

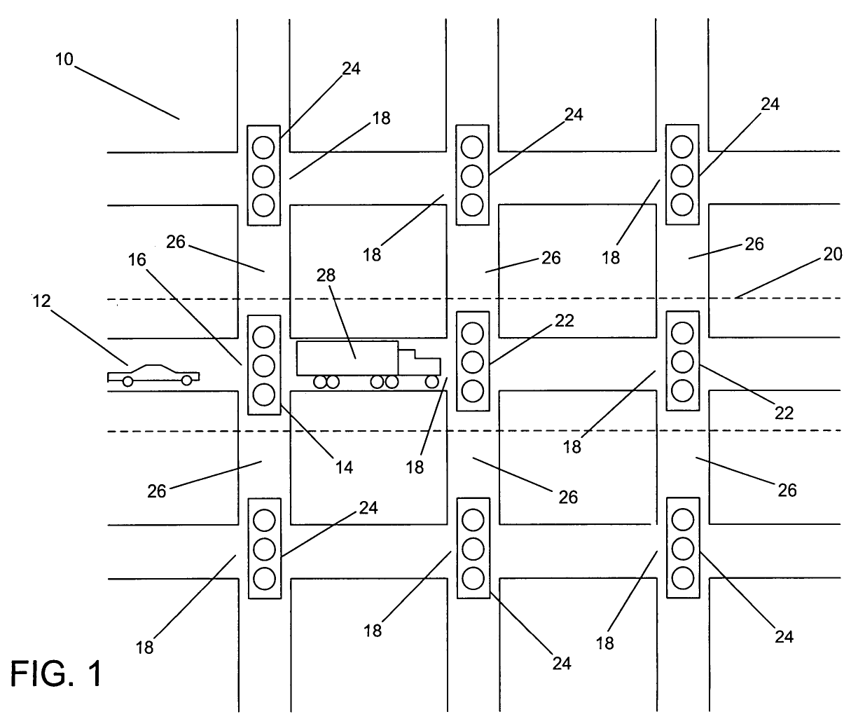

Turning now to the drawings, a preemption system in accordance with the present invention is illustrated in FIG. 1. The preemption system 10 includes a preempting vehicle 12 equipped with hardware (not shown) capable of communicating with and preempting the traffic signals 14 of an inbound intersection 16. The inbound intersection includes traffic signals that are controlled by a traffic signal controller (not shown). The traffic signal controller is equipped with a preemption system capable of receiving communications from the preempting vehicle and preempting the traffic signals in response to received communications. The traffic signal controller is also capable of communicating with traffic signal controllers at distant intersections 18. The communication of the preemption of the traffic signal controller at an inbound intersection can result in the preemption of traffic signals at distant intersections. In one embodiment, the traffic signal controllers at distant intersections are programmed to create a preemption corridor 20, which results in the preemption of traffic signals 22 in the most likely direction of travel of the preempting vehicle. In addition, embodiments may also preempt the traffic signals 24 along side streets 26 to the preemption corridor to facilitate clearing traffic congestion 28 from the preemption corridor. Although the preemption corridor is illustrated as a direct path, in other embodiments the preemption corridor may not be a straight path.

The hardware mounted on the preempting vehicle that is capable of communicating with and preempting the traffic signals of an inbound intersection can be implemented using suitable hardware from any known preemption system. In one embodiment, the hardware described in U.S. patent application Ser. No. 10/811,075 can be used to implement the hardware on the preempting vehicle. The disclosure of U.S. patent application Ser. No. 10/811,075 is incorporated herein by reference in its entirety. In other embodiments, other GPS (Global Positioning System) base preemption techniques can be used. In several embodiments, optical preemption techniques such as those used in the Opticon system manufactured by the 3M Company of St. Paul, Minn. Other embodiments can utilize preemption systems based on sirens. The implementation of embodiments of traffic signal controllers in accordance with the present invention is discussed further below.

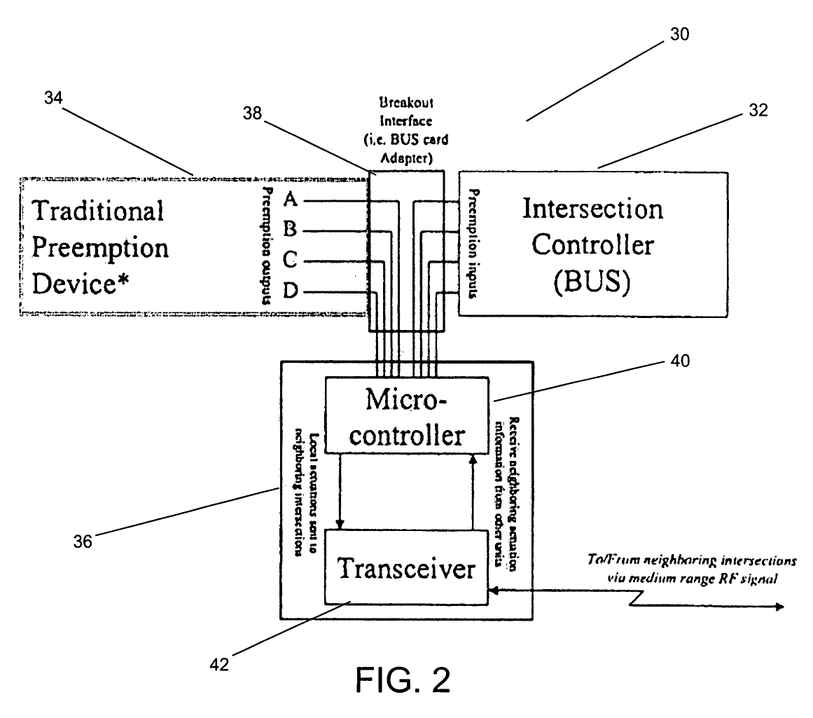

An embodiment of a traffic signal controller in accordance with the present invention is illustrated in FIG. 2. The traffic signal controller 30 includes an intersection controller 32.

The intersection controller is connected to a preemption device 34 and a long-range preemption module 36 via a breakout interface 38.

In one embodiment, the intersection controller is a conventional intersection controller such as a NEMA TS2 M52 Controller manufactured by Siemens ITS of Austin, Tex., possessing a plurality of preemption inputs. The preemption inputs are used to receive signals from external devices instructing the intersection controller to break from the regular signal progression. The preemption inputs also indicate to the intersection controller the traffic signals that should be displayed during the period of preemption. In other embodiments, other intersection controllers capable of being preempted can be used. For example, the intersection controller can be implemented using other types of controllers such as 170, 270 and other NEMA (North American Electrical Manufacturers) standard controllers.

The preemption device can be implemented using the intersection hardware of any preemption system. Known preemption systems provide electronics to receive information from preempting vehicles and are capable of deciding whether preemption should occur.

Such systems also include the functionality to provide input signals to the intersection controller necessary to preempt the intersection in the manner required by the preempting vehicle. In one embodiment, the intersection hardware described in U.S. patent application Ser. No. 10/811,075 can be used to implement the preemption device.

In several embodiments of traffic signal controllers in accordance with the present invention, the outputs of the preemption device are routed through the long-range preemption module. The long-range preemption module provides signals to the intersection controller to preempt the intersection in response to signals generated by the preemption device and/or in response to signals received from neighboring intersections. The long-range preemption module is also responsible for resolving conflicts between the different preemption requirements of a preemption request communicated via the preemption device and a concurrent preemption requested received from a neighboring intersection.

In one embodiment, the long-range preemption module includes a microcontroller 40 that is connected to a transceiver 42. The microcontroller receives input signals from the preemption device and the transceiver. The microcontroller provides output signals to the intersection controller and the transceiver. In several embodiments, the microcontroller can also receive input signals from the intersection controller in order to monitor the state of the intersection. The transceiver communicates with neighboring intersections. The transceiver can receive messages from nearby intersections informing it of their preemption. In the event that the intersection is preempted by an incoming vehicle, the transceiver can send messages to neighboring intersections informing them that it has been preempted.

In one embodiment, the microcontroller is implemented using a LP3100 manufactured by ZWorld of Davis, Calif. In other embodiments, any suitable microcontroller or combination of processing elements can be used to implement the microcontroller 40.

In one embodiment, the transceiver is implemented using spread spectrum radio equipment manufactured by Freewave Technologies of Boulder, Colo. In other embodiments, electronics designed to use one of many wireless or wired communication protocols can be used to communication between traffic signal controllers at neighboring intersections.

As discussed above, a breakout interface is used to route signals between the preemption device to the long-range preemption module and between the long-range preemption module and the intersection controller. In one embodiment, a custom PC board with bus connectors is used to establish the necessary connections between the electrical interfaces. In other embodiments, other techniques for building custom connectors can be utilized. In one embodiment, the custom connector is constructed to comply with the NEMA TS 1 and TS 2 standards.

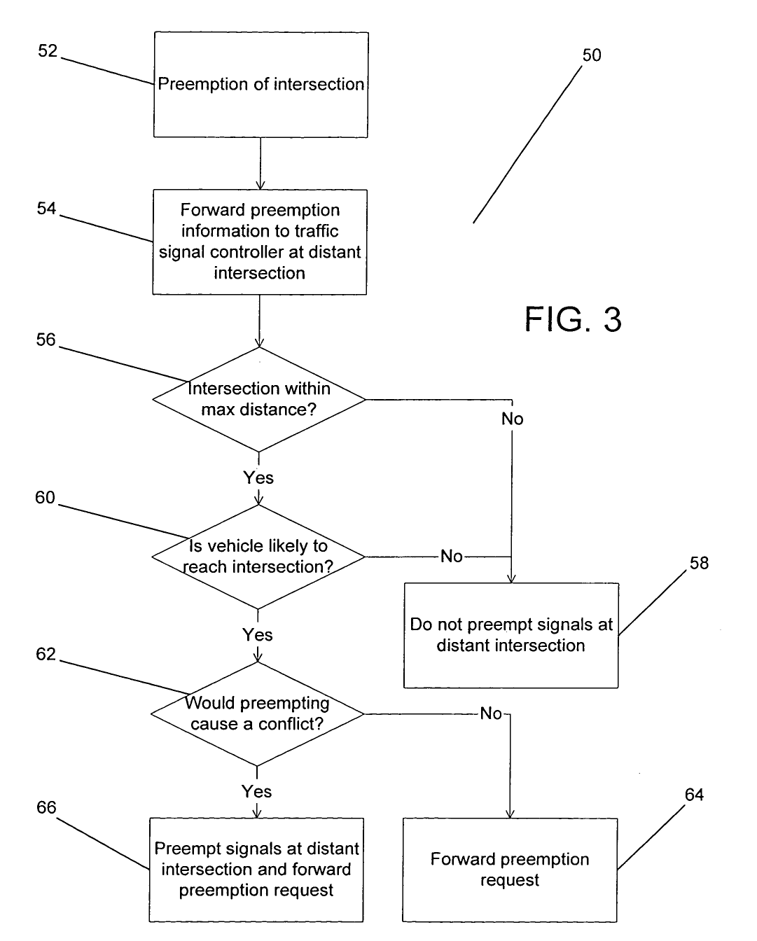

Turning now to FIG. 3, a flow chart illustrating a process for forwarding a long-range preemption request to a traffic signal controller located at a distant intersection is illustrated. The process 50 commences with the preemption (52) of an intersection by a preempting vehicle. The traffic signal controller at the preempted intersection then forwards (54) the preemption information to traffic signal controllers at distant intersections. In one embodiment, the preemption information includes an intersection identifier for the preempted intersection, the geographic position of the preempted intersection and the state of all of the preemption direction inputs to the intersection controller of the preempted intersection. In other embodiments, additional information or alternative ways of characterizing the above information can be communicated.

The traffic signal controller at the distant intersection initially determines whether the preemption request is a request that has already been forwarded to it. If it is not, then the traffic signal controller deals with the preemption request. Otherwise, the preemption request is ignored. The traffic signal controller at the distant intersection uses the forwarded information to determine (56) whether the distant intersection is close enough to the preempted intersection to warrant preempting the distant intersection as well. If the distant intersection is located a distance from the preempted intersection that is greater than a predefined maximum distance, then the distant intersection is not preempted (58). If the distance is less than the maximum distance, then the traffic signal controller at the distant intersection determines (60) whether the preempting vehicle is likely to pass through the distant intersection. In one embodiment, the traffic signal controller determines the statistical likelihood that the vehicle will eventually reach the distant intersection. This calculation can utilize information concerning whether the distant intersection lies within a preemption corridor and the distance of the intersection along a side street if it is not within the preemption corridor. In other embodiments, other techniques can be used to determine if the vehicle is likely to travel through the distant intersection including using historical information concerning the path traveled by preempting vehicles that have preempted the preempted intersection.

In one embodiment, the statistical calculation involves the use of the expected speed of a vehicle on a given street near a given intersection. For each traffic signal controller at each distant intersection, a velocity “window” factor is used for each inbound direction:

Vmin is the minimum expected speed of a vehicle and Vmax is the maximum expected speed of a vehicle. These intersections use the last, best known position of the vehicle that is forwarded by inbound intersections equipped with conventional preemption hardware. This is most often calculated based on when the conventional preemption system stops triggering an inbound intersection because it passes through the intersection (such as with optical systems). The inbound intersection records the time and position of the crossing and forwards it to distant intersections. The position can also be calculated using location information from GPS preemption systems. When a distant intersection receives the position information, it starts a timer. It uses known distances between itself and the inbound intersection, combined with the velocity “window” to determine a time window that it will preempt.

For example, Intersection A is equipped with a conventional optical preemption system and Intersection B is equipped with only forwarding preemption. Also, Intersection A and Intersection B are 1000 feet apart, and that the velocity “window” for this path is between 40 ft/sec (25 MPH) and 80 ft/sec (50 MPH). An emergency vehicle approaches and crosses Intersection A, which identifies that the optical trigger lapses, records the time and position of the crossing, and forwards the information to Intersection B. Upon receipt of the forwarding trigger, Intersection B starts a “window” timer. Based on the distance, Intersection B will start preemption when the timer exceeds 12.5 (1000/80) seconds, and will stop preemption when the timer exceeds 25 seconds. Some time padding may also be applied. More advanced versions of this embodiment may adjust the velocity “window” based on such factors as time-of-day, day-of-week, dynamic congestion information (provided by intersection controllers), or priority information forwarded by the vehicle.

If the traffic signal controller at the distant intersection determines (60) that the preempting vehicle is not likely to travel through the distant intersection, then the distant intersection is not preempted (58). When the traffic signal controller determines (60) that the preempting vehicle is likely to travel through the distant intersection, then the traffic signal controller determines (62) whether preempting the distant intersection would create a conflict with any other preemption requests. Resolution of conflicting preemption requests is well known and typically involves determining which request has been assigned the highest priority by the system and honoring that request. If another preemption request has higher priority than the forwarded preemption request, then the traffic signal controller does not preempt the intersection in the manner requested in the forwarded preemption request. Instead, the traffic signal controller of the distant intersection forwards (64) the preemption request to its neighboring intersections. If the preemption request forwarded by the preempted intersection is the highest priority preemption request, then the traffic signal controller preempts (66) the distant intersection in the manner required by the forwarded preemption request and then forwards the preemption request to neighboring intersections.

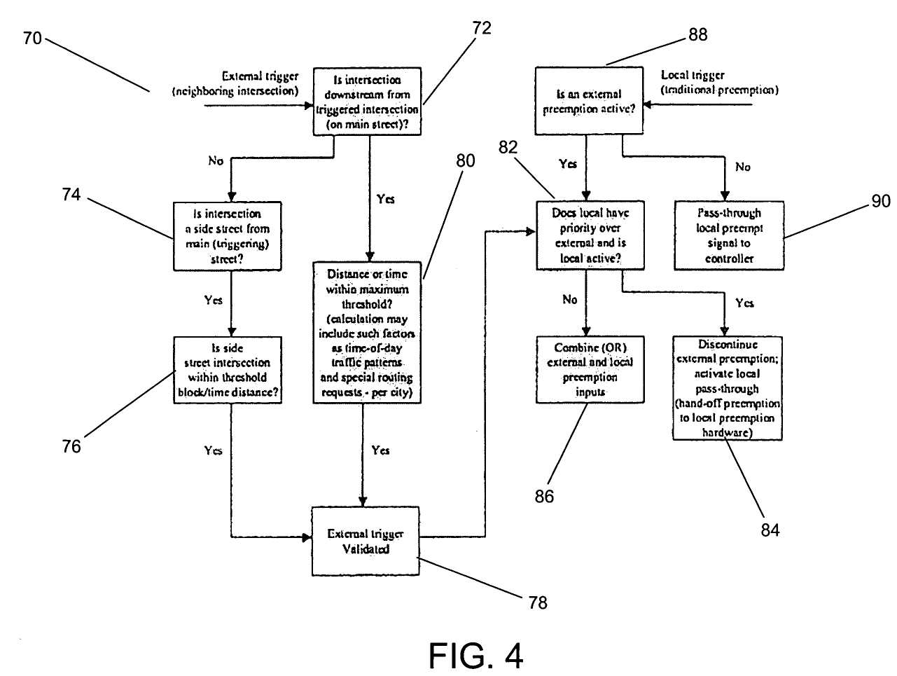

An embodiment of a process in accordance with the present invention for determining whether a distant intersection should be preempted in response to a forwarded preemption request is shown in FIG. 4. The process 70, is initiated by a forwarded preemption request (an external trigger). In response to the forwarded preemption request, the distant intersection determines (72) whether it is downstream (i.e. is the preempting vehicle traveling towards the distant intersection along the preemption corridor) from the preempted intersection. If the distant intersection is not downstream from the preempted intersection, then the distant intersection determines (74) if it is on a side street to the preemption corridor. If it is not, then the distant intersection ignores the preemption request. If the distant intersection is on a side street, then the distant intersection determines (76) whether it is within a threshold distance and/or time of the preemption corridor. If not, then the preemption request is ignored. If the distant intersection is within the threshold, then the forwarded preemption request is validated (78).

If the distant intersection is downstream from the preempting intersection, then the distant intersection determines (80) whether the distance between the preempting intersection and the distant intersection and/or the estimated time of arrival of the preempting vehicle at the distant intersection satisfy a predetermined threshold. Satisfaction of the threshold(s) results in the validation (78) of the forwarded preemption request. Otherwise, the forwarded preemption request is ignored.

The process then attempts to resolve any conflicts that may result from multiple preemption requests at the distant intersection. The process determines (82) whether a vehicle with a higher priority is seeking to directly preempt the intersection. If a higher priority vehicle is attempting to directly preempt the intersection, then the forwarded preemption request is ignored and the preemption request from the higher priority vehicle is honored (84). In one embodiment, the distant intersection can forward the preemption request to neighboring intersections. If the forwarded preemption request has the highest priority, then the distant intersection honors (86) the forwarded preemption request and forwards the preemption request to neighboring intersections.

The process can also be initiated by a direct preemption request (a local trigger) sourced from a vehicle approaching the distant intersection. The distant intersection responds to the direct preemption request by determining (88) whether a forwarded preemption request is currently active at the distant intersection. If a forwarded preemption request is not active, then the distant intersection honors the direct preemption request (90). When a forwarded preemption request is active, then the distant intersection resolves the conflicting preemption requests in the manner described above (see description in relation to 82-86).

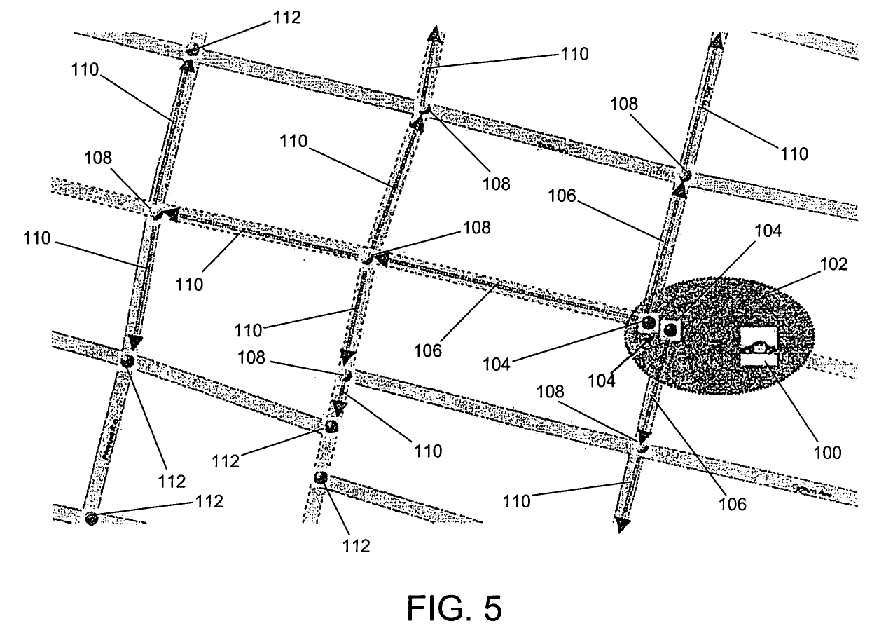

Turning now to FIG. 5, the manner in which the system responds to a single preemption request is schematically illustrated. The preempting vehicle transmits a preemption request that can be received within a limited range 102 of the preempting vehicle. Intersections 104 within this limited range are directly preempted by the preempting vehicle (unless there is a conflicting preemption request). These intersections forward the preemption request (the forwarding of the preemption request is indicated by a first set of arrows 106).

The forwarded preemption requests are received at neighboring intersections 108, which are then preempted provided the necessary preemption requirements are met. These intersections forward the preemption requests (the forwarding of the preempting request by neighboring intersections is indicated by a second set of arrows 110). The process repeats until the intersections 112 receiving the preemption requests no longer satisfy the preemption requirements.

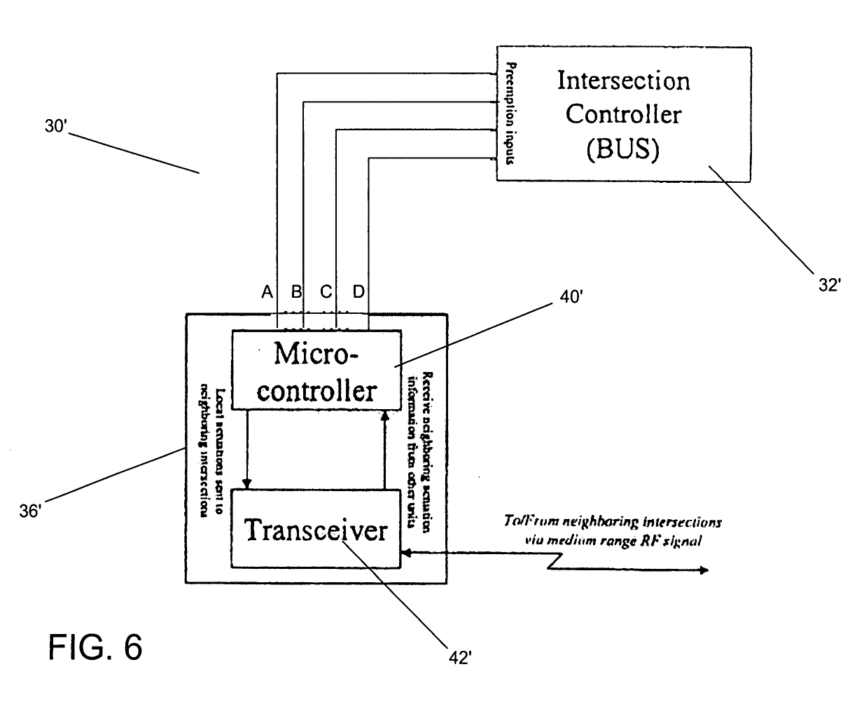

Another embodiment of a traffic signal controller in accordance with the present invention is shown in FIG. 6. the traffic signal controller 30′ is similar to the traffic signal controller 30 shown in FIG. 2 with the exception that the traffic signal controller does not include a preemption device. The traffic signal controller includes a a long-range preemption module 36′ directly connected to the preemption inputs of an intersection controller 32′. The long-range preemption module and the intersection controller can be implemented in the manner described above, but without the need to accommodate a preemption device. The embodiment illustrated in FIG. 6 can be used to provide preemption capabilities for intersections that cannot be directly preempted. In such a configuration, major intersections can include direct preemption capabilities and intervening intersections can be preempted as a result of forwarded preemptions from the major intersections.

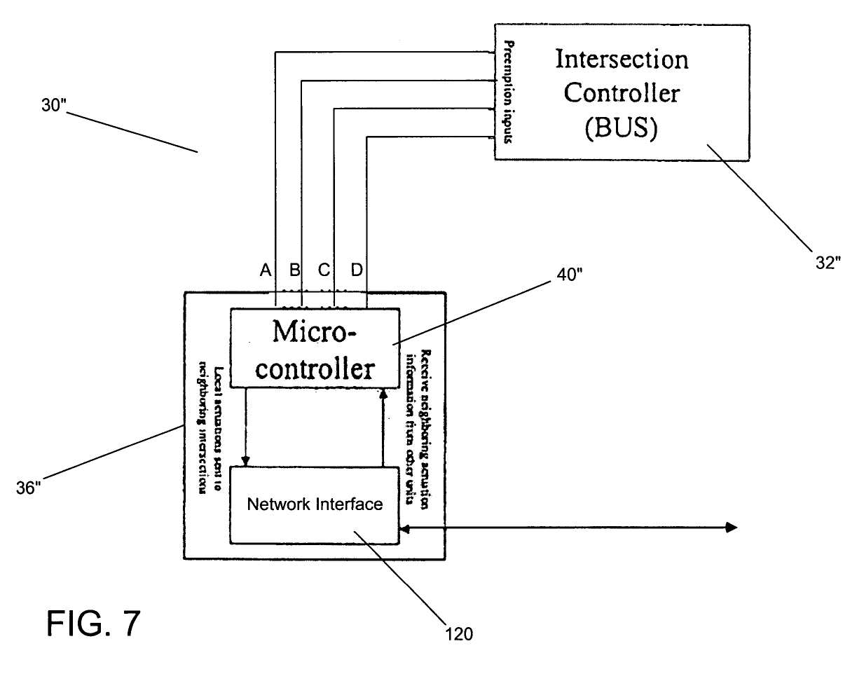

A further embodiment of a traffic signal controller in accordance with the present invention is illustrated in FIG. 7. The traffic signal controller 30″ is similar to the traffic signal controller 30′ shown in FIG. 1 with the exception that the long-range preemption module is connected to a wired network via a network interface 120. In one embodiment, the wired network could be implemented as an Ethernet LAN. In other embodiments other wired network protocols can be utilized. The use of a wired network can simplify the implementation of networks as addressed message routing can be used to forward messages between intersections and can avoid a single intersection receiving multiple messages containing the same preemption request from neighboring intersections.

Other embodiments of traffic signal controllers in accordance with the present invention, such as the traffic signal controller 30 illustrated in FIG. 2 can be connected to a wired network. In addition, the connection to the wired network can be made directly to the intersection controller. In instances where the intersection controller is directly connected to a wired network, the software of the intersection controller can be modified in accordance with the processes described above to implement the necessary forwarding and receipt of preemption requests and to resolve conflicts between forwarded preemption requests and directly received preemption requests.

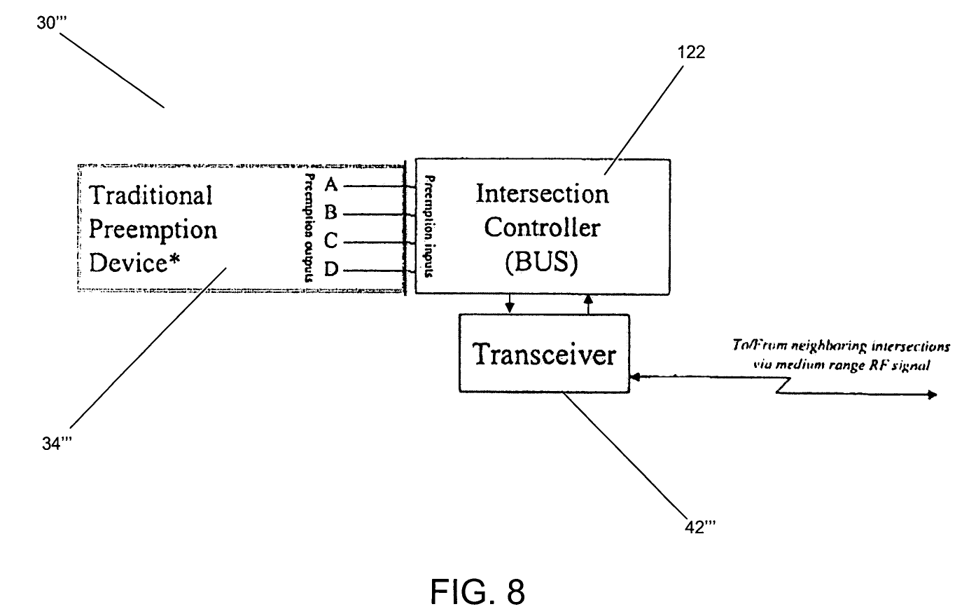

An embodiment in accordance with the present invention of a traffic signal controller where the software of an intersection controller is modified to implement the processes described above is illustrated in FIG. 8. The traffic signal controller 30′″ includes an intersection controller 122 that is programmed to implement the forwarded preemption handling processes described above. The intersection controller is connected to a preemption device 34′″ and the intersection controller is programmed in accordance with the present invention to resolve conflicts between forwarded preemptions and direct preemption requests. The intersection controller is directly connected to a transceiver 42′″, which is similar to the transceiver 42 described above in relation to FIG. 3. The intersection controller can use the transceiver to forward and receive preemption requests.

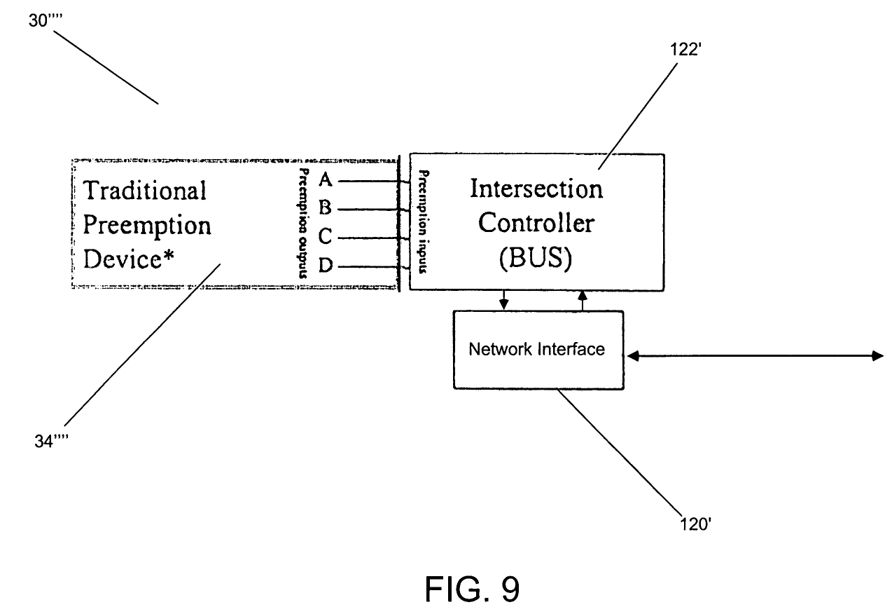

An embodiment of a traffic signal controller including an intersection controller programmed to handle forwarded preemption requests and resolve conflicting requests that is connected to distant intersections via a wired network is illustrated in FIG. 9. The traffic signal controller 30″″ includes an intersection controller 122′ that is connected to a preemption device 34″″ and a network interface 120′. The intersection controller is similar to the intersection controller 120 illustrated in FIG. 8, however, the intersection controller communicates with distant intersections via a network interface, which is similar to the network interface shown as 120 in FIG. 7. Preemption requests can be forwarded and received via the network interface.

Although the foregoing embodiments are disclosed as typical, it would be understood that additional variations, substitutions and modifications can be made to the system, as disclosed, without departing from the scope of the invention. For example, any number of vehicle estimation techniques can be used and any number of different devices can be used to implement the processes described above and variations of these processes that fall within the scope of the invention. In addition, any variety of different methods of communicating information between intersections can be used to forward preemption requests. Moreover, traffic signal controllers in accordance with the structures and processes of the present invention can resolve conflicts between more than two preemption requests including conflicts resulting from multiple forwarded preemption requests. Accordingly, the scope of the invention should be determined not by the embodiments illustrated, but by the appended claims and their equivalents.

1. A traffic signal controller, comprising;
a microcontroller configured to receive forwarded preemption requests from a network; and
wherein the microcontroller is configured to evaluate information included in a preemption request against a predetermined set of criteria; and
wherein the microcontroller is configured to preempt a sequence of traffic signals when the information forwarded in a preemption request satisfies the predetermined set of criteria.

2. The traffic signal controller of claim 1, further comprising:
an intersection controller having preemption inputs;
a long-range preemption module that is connected to the intersection controller preemption inputs and which includes the microcontroller and a transceiver; and
a preemption device connected to the long range preemption module;
wherein the network is a wireless network.

3. The traffic signal controller of claim 1, further comprising:
an intersection controller having preemption inputs;
a long-range preemption module that is connected to the intersection controller preemption inputs and which includes the microcontroller and a network interface; and
a preemption device connected to the long range preemption module;
wherein the network is a wired network.

4. The traffic signal controller of claim 1, further comprising:
an intersection controller including the microcontroller and having preemption inputs;
a preemption device connected to the intersection controller via the preemption inputs;
a transceiver connected to the intersection controller;
wherein the network is a wireless network.

5. The traffic signal controller of claim 1, further comprising:
an intersection controller including the microcontroller and having preemption inputs;
a preemption device connected to the intersection controller via the preemption inputs;
a network interface connected to the intersection controller;
wherein the network is a wired network.

6. The traffic signal controller of claim 1, wherein:
the preemption request is forwarded from a traffic signal controller that includes an intersection controller;
the traffic signal controller is located at a preempted intersection;
the forwarded preemption request includes information concerning:
the geographic location of the preempted intersection; and
the state of the preemption inputs of the intersection controller of the preempted intersection.

7. The traffic signal controller of claim 1, wherein:
the forwarded preemption request was generated in response to a preempting vehicle;
the microprocessor is configured to evaluate the information by generating an estimated time of arrival for the preempted vehicle using a velocity window.

8. The traffic signal controller of claim 7, wherein the microprocessor is configured to evaluate the information by determining the velocity window based on present traffic conditions.

9. The traffic signal controller of claim 1, wherein the microprocessor is configured to resolve preemption requests made directly to the traffic signal controller by a vehicle and forwarded preemption requests.

10. The traffic signal controller of claim 9, wherein:
the preemption request from the vehicle and the forwarded preemption request include priority information; and
the microprocessor is configured to preempt a traffic signal sequence in a manner consistent with the highest priority preemption request.

11. A traffic signal controller, comprising:
means for receiving forwarded preemption requests;
means for evaluating the appropriateness of a forwarded preemption request; and
means for preempting traffic signals in response to an appropriate forwarded preemption request.

12. The traffic signal controller of claim 11, further comprising:
means for receiving direct preemption requests; and
means for resolving conflicts between direct preemption requests and forwarded preemption requests.

13. A traffic signal control system, comprising:
a plurality of traffic signal controllers;
wherein at least one traffic signal controller includes a preemption device that can be preempted by a vehicle equipped with hardware capable of communicating a preemption request to the preemption device;
wherein the traffic signal controller is configured to send a forwarded preemption requests via a network;
wherein at least one of the traffic signal controllers is configured to receive the forwarded preemption request via the network.

14. The traffic signal control system of claim 13, wherein the network is wireless.

15. The traffic signal control system of claim 13, wherein the network is wired.

16. A method of preempting an intersection, comprising:
receiving a preemption request forwarded from another intersection;
determining whether the forwarded preemption request satisfies at least one predefined criteria;
determining whether the forwarded preemption request conflicts with any preemption request currently being honored by the intersection;
when the preemption request satisfies the predefined criteria and does not conflict with other preemption requests, preempting the intersection and forwarding the preemption request to neighboring intersections.

17. The method of claim 16, wherein the preemption request includes information concerning the geographic location of the intersection that is the source of the preemption request and the manner in which the preempted intersection has been preempted.

18. The method of claim 16, wherein:
the forwarded preemption request was originated at an originating intersection;
determining whether the forwarded preemption request satisfies at least one predefined criteria comprises determining whether the originating intersection is within a predetermined distance of the intersection.

19. The method of claim 16, wherein:
a vehicle preempted an originating intersection that forwarded the preemption request;
determining whether the forwarded preemption request satisfies at least one predefined criteria comprises determining whether the vehicle will arrive at the intersection with sufficient probability.

20. The method of claim 16, wherein:
a vehicle preempted an originating intersection that forwarded the preemption request;
determining whether the forwarded preemption request satisfies at least one predefined criteria comprises determining whether the vehicle will arrive at the intersection within a predetermined time.

21. The method of claim 16, wherein:
the forwarded preemption request is assigned a priority;
other preemption requests are also assigned priorities;
determining whether the forwarded preemption request conflicts with any preemption request currently being honored by the intersection comprises determining whether the forwarded preemption request is of a higher priority than all other preemption requests.

22. The method of claim 21, wherein the other preemption requests can include at least one preemption request made directly to the intersection by a vehicle.

23. The method of claim 21, wherein the other preemption requests can include at least one other preemption request forwarded to the intersection by another intersection.

24. The method of claim 16, wherein preempting the intersection comprises establishing both traffic and pedestrian signals in accordance with the preemption request.

25. The method of claim 16, wherein forwarding the preemption request to neighboring intersections involves broadcasting the preemption request over a wireless network.

26. The method of claim 16, wherein forwarding the preemption request to neighboring intersections involves sending the preemption request to neighboring intersections via a wired network.
